(19) United States
(12) Patent Application Publication
(10) Pub. No.: US 2009/0262343 A1
(43) Pub. Date: Oct. 22, 2009

(54) INFRARED SPECTROSCOPY OF MEDIA, INCLUDING AQUEOUS

(76) Inventor: William B. ARCHIBALD, Livermore, CA (US)

Correspondence Address: MOTS LAW, PLLC, 1629 K STREET N.W., SUITE 602, WASHINGTON, DC, 20006-1635, US

(21) Appl. No.: 12/426,547

(22) Filed: Apr. 20, 2009

Related U.S. Application Data
(60) Provisional application No. 61/046,070, filed on Apr. 18, 2008.

(51) Int. Cl. G01N 21/01

(52) U.S. Cl. 356/246

(57) ABSTRACT

Wide band infrared spectroscopy of molecules in a variety of media is provided by apparatuses, materials and methods that allow real time spectroscopic view of molecules such as proteins in native environments. Precisely machined sample holders and algorithms are used to reduce spectroscopic effects of solvents such as water. Multiple samples can be analyzed simultaneously. Embodiments provide secondary and tertiary structure information of substances such as proteins based on molecular interactions that can be monitored and manipulated in real time.

This application receives priority from provisional application No. 61/046,070 filed Apr. 18, 2008 for inventor William Archibald, the entire contents of which are specifically incorporated by reference in their entirety.

### BACKGROUND

Molecular analysis via spectroscopy is a powerful technique for investigating chemical structure. Unfortunately, however, infrared analyses are limited by serious obstacles such as water absorption, limited optic materials, and calibration difficulties. Workers in this field have addressed the problems by mathematical treatment of broadband data, rigorous use of water correction techniques and by careful consideration of optic materials for handling and optically studying samples.

Fourier transform of imaging data from an infrared focal plane detector is described, for example, by Lewis et al. Anal. Chem. 67: 19, pp. 3377-3381. Lewis introduced an instrument that uses infrared “data collection and processing,” which “is similar to that performed for conventional FT-IR studies.” Lewis explained that “[a]nalysis involves first collecting a step scan image sequence data set of background, typically air” and correcting for the background by taking another image using the same sample holder.

Such FT-IR analysis of biomolecules in aqueous solution is very difficult because of the high molar concentration and absorptivity of water. Consequently, most spectral analysis investigations generally forego the use of infrared wavelengths. And, those who attempted the analysis of aqueous samples have had to wrestle with water blanking to remove water effects and get crippling sensitivity. Dousseau et al., for example offered a “spectral subtraction of water” technique wherein the “combination band of water at ˜2125 cm⁻¹ is used as an internal intensity standard for the determination of the scaling factor.” Dousseau teaches that a way forward out of this conundrum is to make measurements and then use an algorithm to subsequently correct water contributions, using an internal standard See Dousseau et al. App. Spect. 43: 3, pp. 538-542. Even this teaching only reduces error “of the order of 2% in the region of the amide I and amide II bands,” which are of particular interest for biomolecules such as protein.

Rahmelow and Hubner reviewed the difficulties in this field and evaluated the “long-term reproducibility of a set of water spectra in the infrared region with cell thickness of less than 10 microns” App. Spect. 51: 2, pp. 160-170. This group concluded that “[t]he subtraction of water from an aqueous protein solution reduces the spectral range for a correction to 2300-1800 cm⁻¹.” The group in particular emphasized the control of or correction of temperature effects between measurements carried out at different times, stating that it “seems difficult” to obtain “further improvement in the achieved error levels of 3-5% of the protein absorbance around 1650 cm⁻¹.” These workers also concluded that correction for water requires that temperature be “kept constant within a tenth of a degree” and that “water subtraction accuracy around 1650 cm⁻¹ of aqueous protein solutions can be enhanced by including the range 4000-3650 cm⁻¹.”

Sample handling for IR studies is a big problem. Materials such as calcium fluoride glass typically are employed to make reusable flow cells or cuvettes. See Venyaminov and Prendergast, for example, who use water subtraction algorithms on spectral data and who emphasize proper sealing of the sample cell to prevent the evaporation of water during and between measurements Anal. Biochem. 248: pp. 234-245. This group concludes that “one must have a well-matched pair or IR cells and use the shuttle system” or use “mathematically based subtraction” with “only one cell” for both solution and neat solvent. This group again emphasized the common understanding in this field that “obviously it is important to select a spectral range where the water absorbance does not overlap with that of the solute” (p. 241), and that furthermore “does not overlap with bands belonging to biomacromolecules” (p. 240). This reference explains that “the absorbance of H₂O band at 2127.5 cm⁻¹ . . . is widely used for correcting water absorbance” (p. 241 left side) and that “[t]he best spectral regions for this purpose are in the vicinity of ‘3645 cm⁻¹ (H2O) and ‘2770 cm-1 (D2O)” (p. 241 right side).

Other sample handling techniques for FT-IR of aqueous protein samples are described in US. 2005/0170521 “Multiple Sample Screening Using IR Spectroscopy” U.S. Ser. Nos. 10/366,464; 11/038,435; 11/038,550; 11/039,276; 11/133,490 and PCT/US05/44550, by Archibald, the contents of which, and especially details of construction and use of sample handling and sample holders, are specifically incorporated by reference in their entireties.

A theme in the field, thus, is the extreme difficulty of infrared analysis of biomolecules in aqueous solution. Any new technique, apparatus, material or method that can alleviate the problems can bring immense benefits. This is particularly true with respect to protein studies, wherein spectroscopic changes associated with secondary, tertiary and quaternary structure of proteins promise to reveal immensely important biologically relevant information, if a sensitive enough tools were available for analysis in the infrared regions associated with protein hydrogen bonding.

### DESCRIPTION OF THE DRAWINGS

FIG. 1 shows two cross sectional views of representative unitized sample holders according to an embodiment.

FIG. 2 is a top view of a sample holder.

FIG. 3 is a close up side view of the sample application port of the holder from FIG. 1.

FIG. 4 is a top view of a sample holder that has an appendix to accommodate volumetric changes.

FIG. 5 is a top view of multiple sample holders prepared within a single material.

FIG. 6 is a top view of a representative sample holder.

FIG. 7 is a top view of a representative sample holder.

FIG. 8 is a top view of a sample holder that has a chemistry reaction portion.

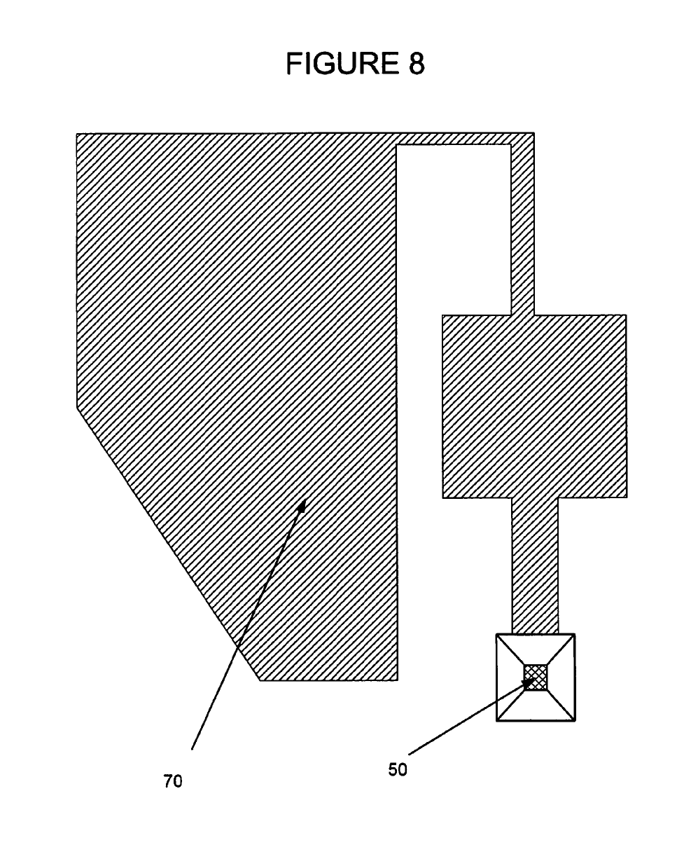

FIG. 9 is a view of a cassette.

### DETAILED DESCRIPTION OF THE INVENTION

### Overview

Devices, materials and methods were found that potentiate sensitive wide band spectroscopy measurements of biomolecules with unexpected accuracy, even in aqueous solution. New kinds of materials designed for unrelated purposes were machined with very high precision and reproducibility, and allowed the use of previously disfavored sensitivity enhancement techniques on aqueous samples.

Embodiments include wide band infrared detection instrumentation that simultaneously can assay multiple aqueous samples. Unitized sample holders were inexpensively made with very high precision, thereby allowing alternative, previously unfavored techniques for sensitivity improvement. Spectroscopic effects of water were further minimized by double subtractive comparison of wide band scan signals from aqueous samples. Other embodiments alleviate background noise in chemical pixels by measuring multiple blanks simultaneously. In an embodiment, an FT-IR instrument operates with one or more samples that are placed at specific read location(s) within the instrument and subtracts electronic noise/chemical background.

Sample holders were discovered that provide automated infrared analysis of biological samples. In an embodiment, aqueous samples are loaded into a machined, infrared radiation transparent sample chip having machined semiconductor impedance matching cells to accommodate biological samples and background (reference fluid only) samples. The machined chip typically is mounted in a larger holder such as a plastic disposable such as polypropylene or polyethylene or a printed circuit board material such as FR4, and/or a machinable ceramic such as macor, for convenient transport and manipulation. The holder preferably has one or more friction stops and alignment ridges for convenient and accurate placement within an instrument.

Other processing steps that provide unexpected advantages include, for example, oxidation of one or more surfaces of the chip silicon to a desired thickness that minimizes optical impedance to probing light into or out of the sample space. Specific dimensions of the cavities and oxide coatings were found that improve light throughput for specific wavelengths, as detailed below.

In evaluating sample chips with aqueous materials in temperature studies, it was found that evaporation losses could be minimized by plugging apertures with a high viscosity material and/or by adding an appendix to the sample chamber. Viscosity materials used in combination with sample chips fabricated with specific dimensions and aperture openings were found to work particularly well, and are described last.

### Machined, Optic Impedance Matching Cells as Passivated Sample Holders

A machined sample holder has very precise and reproducible dimensions, that provides a precise optic device for one time use and that optionally has controlled surface passivation for use in wet diagnostics. Materials were found that, through a surprising coincidence of high precision, oxidized surface coating and selected dimensions, unexpectedly allowed new background removal correction of biological aqueous samples.

The transparent, machined sample holder comprises typically as few as 4 and as many as 100 or more sample accepting volumetric spaces within. Preferably each space has an associated inlet port and a vent, to allow entry of an aqueous sample. Each such unit preferably forms an impedance attenuator cell that has a spectroscopy probe area and optical qualities on each side of the probe area for maximizing light throughput. The unit is unitized, in that everything needed to obtain a measurement can be applied to the cell and the cell can be disposed after use. The machined sample holder preferably is mounted in a cassette that is handled by a person or automatic equipment. Preferably the machined holder is flat, with dimensions that range typically from 0.1 to 2 inch by 0.1 to 2 inch and preferably 0.6 inch by 0.48 inch in long dimension size and from 0.002 to 0.1 inch (preferably 0.1 to 0.4 inch) thick.

Sample chips for use with infrared analysis of aqueous samples, as described herein, preferably are made from a semiconductor material that has a non-zero energy gap, which separates the conduction band from the valence band. In an embodiment, a silicon wafer material is deep etched to form sample cavities, entry ports and vent holes, subsequently bonded to a silicon wafer bottom, and then mounted in a plastic package. The term “deep etch” means that the silicon is etched to at least 2 microns and preferably more than 100 microns.

### Impedance Matching by Passivation

A passivated sample holder according to an embodiment, is transmissive to probing light and has just enough hydrophilicity to allow capillary action, but some hydrophobicity to alleviate or minimize binding of protein. Most desirably, the sample holder is made of a single semiconductor crystal material having a water binding angle of between 45 to 75 degrees, and more preferably between 53 and 57 degrees. Without wishing to be bound by any one theory for this embodiment, it was discovered that a tradeoff exists between having just enough hydrophilicity for capillary action but not more than this to avoid binding up protein.

Impedance matching cells in a preferred embodiment have a cross sectional dimension with a very high reproducibility and a size that is impedance matched with wavelength. Certain wavelengths and size combinations in this regard were found especially desirable and are given, along with their matched cross sectional dimensions in Table 1. A skilled artisan, informed with this description and examples can derive further combinations of wavelength/optic thickness/Rf value for a given material or wavelength that can minimize loss of light.

| | | Thickness of | Thickness of | Thickness of | Thickness of | |
|---|---|---|---|---|---|---|
| | | Impedance | Impedance | Impedance | Impedance | |
| | | Matching Coating | Matching Coating | Matching Coating | Matching Coating | Transmission |
| Impedance | | at 5.9 micron | at 6.0 micron | at 6.1 micron | at 6.5 micron | Efficiency (%) of |
| Matching | Index of | wavelength | wavelength | wavelength | wavelength | Coated Silicon |
| Material | Refraction | (Nanometers) | (Nanometers) | (Nanometers) | (Nanometers) | Sample Holder |
| None | 1 | 0 | 0 | 0 | 0 | 49% |
| Silicon | 1.5 | 986 | 1010 | 1022 | 1075 | 93% |
| Dioxide | | | | | | |
| Silicon Nitride | 2.1 | 704 | 722 | 730 | 768 | 97% |
| Silicon | 1.84 | 804 | 823 | 834 | 877 | 100% |
| Oxynitride | | | | | | |

Semiconductor crystal sample holders made with some of these coating thicknesses and materials were found to work particularly well with these particular light wavelengths. In an especially desirable embodiment at least the outer two surfaces through which probing light passes are passivated with a controlled thickness of controlled Rf material to decrease their optical impedance. A wide variety of fabrication techniques are available to add atoms to a surface, remove atoms and change the optical properties and are known to skilled artisans. Table one exemplifies fabrication materials for particularly desirable wavelengths but others easily may be chosen and are contemplated.

### Semiconductor Crystal Machining

In an embodiment, a set of sample holders, each of which doubles as an optic impedance attenuator, is made by machining a semiconductor but preferably without any doping or chemical processing except for impedance matching oxidation of the surface. Preferably pure silicon is used in crystalline wafer form such as a wafer between 0.1 and 1.0 millimeters thick and preferably between 0.3 and 0.7 millimeters thick. Other semiconductors such as germanium and gallium arsenide can be used but are less favored due to their higher cost.

Preferably the sample holder is a unitary device that comprises two semiconductor wafers that are sealed together in the absence of sealant or adhesive. Preferably only one of the wafers is machined before sealing.

In a preferred embodiment, a first top wafer of pure silicon approximately 0.5 millimeters thick is coated with resist in a suitable pattern and then wet etched by anisotropic wet etching to create prismatic entry and vent ports. The silicon is passive and contains no doped or electrically active regions. A second, bottom wafer approximately 0.5 millimeters thick is heat bonded to one side of the first piece to form a completed sample chip, which contains multiple entry ports and internal cavities to hold aqueous samples during broadband infrared spectroscopy measurements.

The sample holder preferably comprises multiple sample wells with IR transmissive (particularly 4-10 um wavelength) surfaces. Preferably, one layer is processed with etched openings of at least 100 um, preferably 100 to 2000 um thick, and most preferably 300-750 um deep. The openings preferably are vertical and perpendicular to the sample holder surface. In an embodiment at least the sealing surfaces are oxidized to SiO2 for subsequent heat sealing. An embodiment provides one or more (or all) internal (vertical and or oblique cavity) side walls and/or horizontal bottom wall as pure silicon. The pure silicon surface(s) minimize hydrogen bonding and ionic bonding of sample biomolecules in water to the sample holder. Other surfaces and surface coatings that minimize charges and dipoles on the surface are particularly useful for minimizing bonding of samples to the surface. After machining, then a cover layer (preferably the bottom) is added and sealed at least well enough to prevent water leaks during use at regular, one atmosphere pressure. Preferably, the sealing requirements are lower than that used for sealing machined silicon for pressurized gas studies.

Precision Optics with Entry, Exit Holes and Optional Appendix

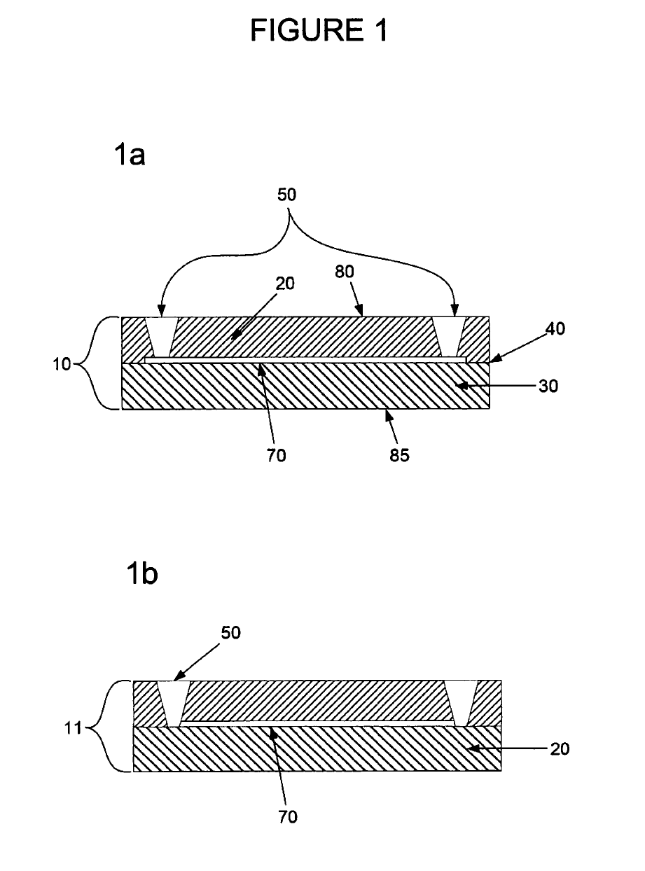

As exemplified in side view of FIG. 1, a precision optic device 10 as described here preferably comprises top layer 20 and bottom layer 30 sealed together along their flat surfaces 40. Deep wells 50 that pass through width 60 of top layer 20 reach optic capillary 70. Both top 20 and bottom 30 preferably are 300 to 3000 microns thick, and more preferably 400 to 900 microns thick. Outer surfaces 80 and 85 preferably are polished optically smooth to a mirror finish.

Also shown in FIG. 1 is an optic device 11 in a related configuration. Deep wells 50 in device 11 partially contact bottom layer 30. In an embodiment (not shown) a first deep well 50 contacts bottom layer 30 and the second deep well does not. The latter embodiment is useful when the bottom layer is conductive and insulated from the optic capillary space 70. Application of a voltage gradient from bottom layer 20 to another electrode contact positioned away from the first deep well may be used for an electric separation technique. Other applications of fabricated materials similarly can lead to electrophoretic or isoelectric separation and are contemplated embodiments. That is, one or more of the components described or referred to herein can be further processed by one or more fabrication techniques to provide specific conductivity. Each such component is intended as an electrode in respective embodiments.

The material for forming the precision optics preferably is a crystalline, undoped semiconductor. The most preferred material, pure silicon, is thought to acquire a Si—OH monolayer surface upon exposure to air and moisture. Because of this layer, in a preferred embodiment, the junction between top layer 20 and bottom layer 30 has some oxide (less than 50 angstoms of oxide layer). In this embodiment sealing oxide line 40 may be very thin (less than 50 angstroms). In another embodiment, sealing line 40 is thicker, typically 100 angstroms or more, and comprises silicon dioxide that has been formed on the two surfaces before their sealing. Line 40 extends to the surfaces of capillary 70 in a desirable embodiment. An optical impedance cell preferably has an anti-reflective coating at least 100 angstroms thick. In an embodiment, however, the cell coating may be a naturally occurring oxide layer formed by exposure of the material to molecular oxygen in the air.

In a preferred embodiment, crystalline top layer 20 has been etched via a simple procedure such as potassium hydroxide wet etching of optic cell 10 and deep wells 50 after patterning with photolithography. Shadow mask lithography, electron beam lithography, thermal evaporation, or other lithography techniques, can be useful in some embodiments. However, impedance attenuators made from silicon or other machined material that are transparent to infrared probing wavelengths preferably are made by reactive ion etching, and more particularly with a base such as KOH. Preferably prismatic openings are made via anisotropic wet etching of the silicon with KOH to create prismatic entry and/or vent ports. Generally, an etch resist pattern is formed, followed by exposure to the ion etching reagent, followed by washing.

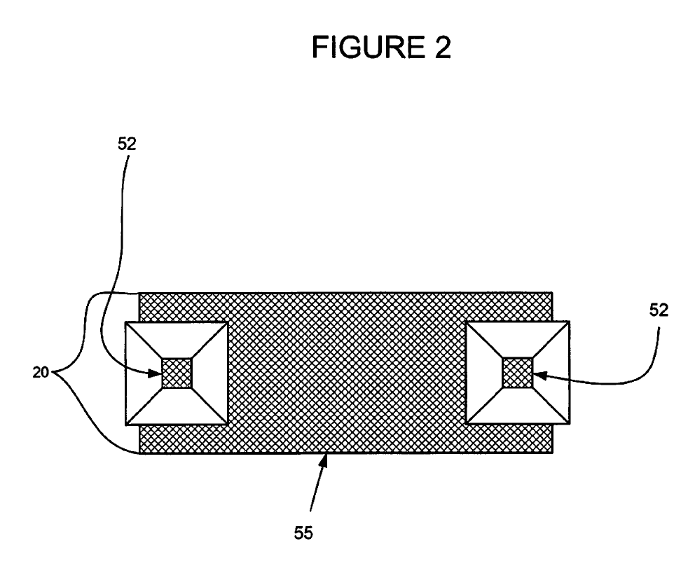

FIG. 2 is a top view of crystalline top layer 20 having deep well 50 (side view not shown) with a top opening 52 having a width preferably between 0.1 and 3 millimeters, more preferably between 0.3 and 1 millimeters and yet more preferably between 0.4 to 0.6 millimeters. The opening preferably is square, and formed by anisotropic etching. Center portion 75 (not shown here) is a read section. In an embodiment, the top and bottom of this micro cuvette are parallel with each other, perpendicular to probing light, and more preferably are treated or coated to form a controlled thickness of desired optical Rf.

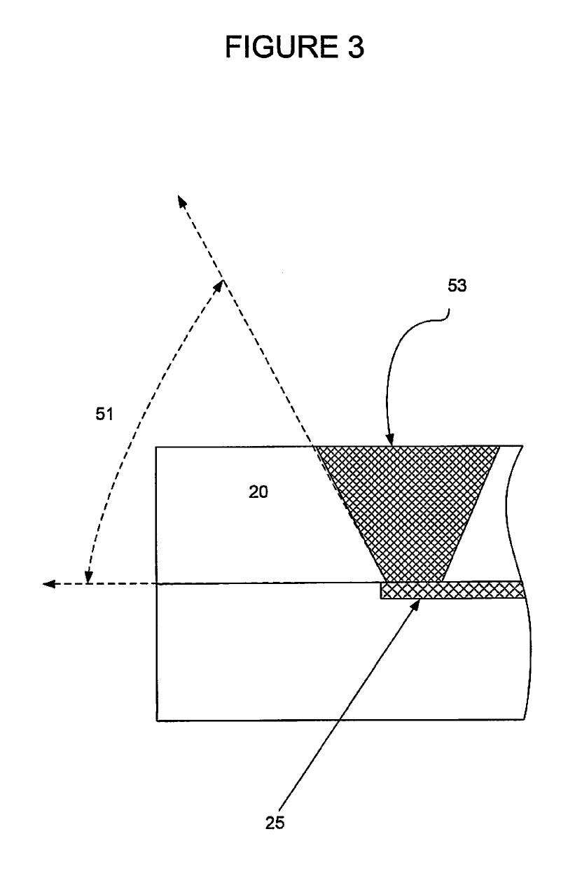

FIG. 3 is a side view, showing well depth 53 that extends through top layer 20 and meets capillary opening 25. The bottom of well 53 forms a particular angle 51 due to the anisotropic etching that in this case is about 52 degrees. Having a sample entry well with wider top and smaller bottom like this is highly desirable. This configuration was found to facilitate flow of sample into the device from initial contact with sample. Desirably, a sample application orifice area is between 10 percent and 90 percent of the well top opening area, and more desirably between 30 percent and 85% of this value.

In an embodiment, the etched wafer surfaces within the structure, which form fluid holding cavities are pure silicon left untreated and relatively hydrophobic, to minimize bonding of sample. In an embodiment, etched surfaces are made more hydrophilic by a further process step (preferably oxidizing) using a known technique. In another embodiment, etched surfaces are oxidized to form SiO2 bonds at an average surface thickness of 0.5 to 5 microns, preferably between 1 and 2 microns thick and more preferably between 1.2 and 1.8 microns thick. Such oxidation and other techniques can be carried out to make a surface hydrophilic. The surface hydrophilicity and particularly vertical or somewhat vertical sample inlet walls, is particularly desirable when using water samples. The hydrophilicity potentiates the use of capillary action for entry of aqueous samples into the machined spaces.

In a desirable embodiment the top surface is hydrophobic and the sample inlets/wells are hydrophilic, to facilitate entry of aqueous samples into the device. In another embodiment the hydrophilicity of at least a portion is controlled by a chemical reaction that may be light activated, UV light activated, electric activated or otherwise controlled.

Desirably, material and/or surface preparation properties are chosen as a tradeoff between facilitating capillary action while minimizing adsorption of biological sample. In particular, glass (generally, amorphous silicon dioxide) can be used in an embodiment, but is a strongly disfavored material, for several reasons. Glass cannot be machined with the desired precision, generally is too opaque to spectroscopic light of desired probing wavelengths, and generally is too absorptive of biomolecules, particularly after etching. A silanol surface, on the other hand is desirable for increasing binding when needed and can be covalently modified for participation in binding reactions such as in a pretreatment chamber section used within a flow path of a device as described herein.

FIG. 1 shows one entrance hole to an impedance attenuator cell and one vent hole. Both holes may be of the same shape and size although in an embodiment, the exit hole is much smaller to minimize evaporation. Preferably, the holes are connected to a common capillary via opposite ends of the long dimension of the capillary.

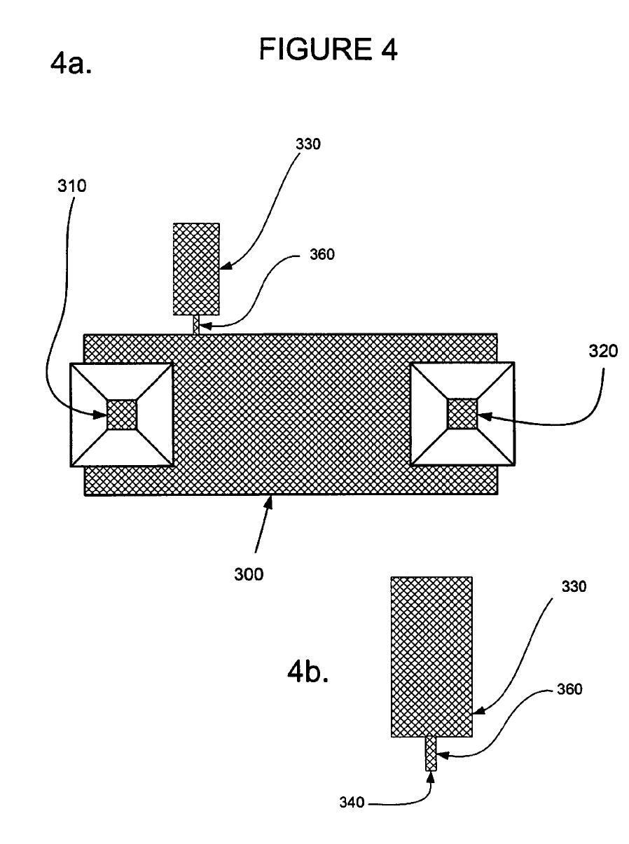

In an embodiment, the impedance attenuator cell further comprises an appendix to handle volume and pressure changes, particularly experienced during sample heating. FIG. 4 is a top view that shows impedance attenuator cell 300 with ingress hole 310, vent hole 320 and appendix 330. Appendix 330 can be positioned anywhere in the “cell space” i.e. connected within the total volume between the bottoms of holes 310 and 320.

Desirably, appendix 330 has an entrance aperture that preferably is rectangular, square, round, or oval, and that has an ingress (entrance) cross sectional area that may be equal to or smaller than cross sectional opening area 340. Most of the body space volume of appendix sack 330 preferably is positioned away from short narrow opening 360 as shown in FIG. 4. In an embodiment, the entire appendix has a constant cross sectional area. Preferably, the volume of appendix 330 is between 0.1% and 5% of the total impedance attenuator cell space. More preferably, the appendix volume is between 0.25% and 2% of the cell space.

A skilled artisan readily can determine positioning, configuration/size and optional surface treatment of the appendix in order to allow an air space to collect within the appendix. The air space can provide relief from pressure changes during use of the impedance attenuator, particularly for use in temperature change studies, where the deep wells have been sealed shut to prevent evaporation. In an embodiment the surface of the appendix is hydrophobic or at least 25% more hydrophobic compared to the rest of the sample holder surface that contacts aqueous sample. The degree of hydrophobicity in this context may be measured by contact angle as is known to skilled artisans in this area.

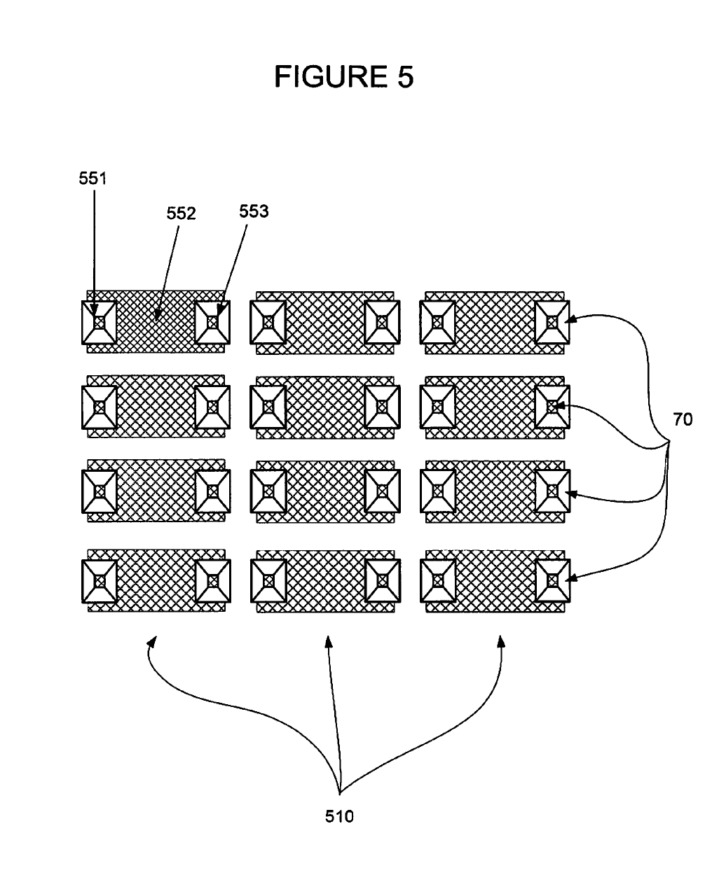

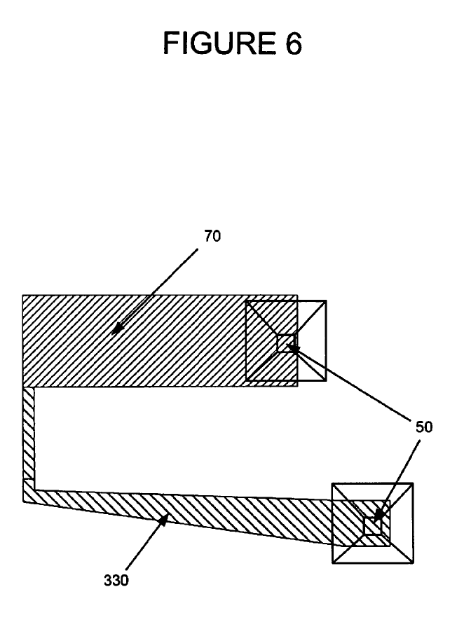

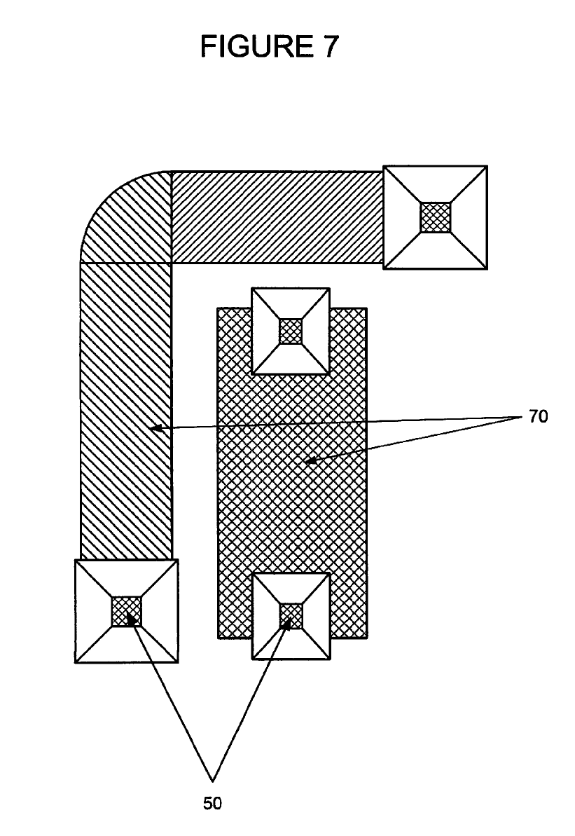

A reader will appreciate other possible configurations of appendices, after review of this disclosure. FIGS. 5 to 7 show appendixes as a long air space between sample ingress holes and vent holes. In an embodiment, the elongated connecting appendix contains a solvent soluble or dispersible material that mixes with an applied sample during use.

In an embodiment, infrared measurements are taken during sample addition or traversal into or through the sample holder. The movement of one or more fluid meniscuses are monitored. For example, a linear distance moved versus a time is determined. This value is compared with a stored or computed value to determine a relative or absolute viscosity of the sample. In a related embodiment, a calibration check is made by monitoring the meniscus travel to ensure that enough sample has been added. If insufficient (too slow or insufficient travel distance) then an error notice would be triggered. Desirably the travel of meniscus past an appendix opening is monitored.

### Formation of Completed Impedance Attenuator by Bonding

To obtain best precision with simplified manufacture, preferably an outer layer of crystal material is machined by polishing, lithography and etching to form very precise capillary channels (with optional appendix(s)) and well holes. The capillary etched bottom side of the top layer is sealed to a plain, preferably very flat, polished layer that preferably is made of the same material. The use of a plain, un-etched bottom makes placement parameters less critical, which simplifies manufacturing. Glass and other ceramics or metals can be used but are less preferred.

Because of the lack of active doped structures, a simple high temperature fusion method can be used for assembly. This no-adhesive method allows lower cost and lower complexity and reduces the potential for chemical interactions with biological samples. For example, the top wafer does not have to be aligned to the bottom, un-etched, wafer as carefully before bonding,

In an embodiment, the holder material is silicon, the surfaces to be bonded have not been treated by a chemical process step and may be considered coated with a light (less than 25 angstroms) layer of mostly silicon hydroxide. The two layers may be pressed together at moderate heat above 400 degrees centigrade for an extended time period or as is known by skilled artisans. In another embodiment where a more hydrophilic surface on the capillary bottom is desired, the layers may be coated with silicon dioxide or even a small amount of acid such as hydrofluoric acid prior to fusion bonding.

Generally fusion bonding is performed by applying high temperature to very flat semiconductor surfaces pressed together. In an embodiment, typically, surface bonds are broken by increasing the bond treatment temperature to above 800 degrees C., which removes OH and H groups bonded to the surface, while not appreciably breaking the Si—O bonds.

In a preferred embodiment silicon nitride or other refractory non-oxide material forms a thin layer at the surface such as for example 10 to 1000 angstroms thick. This thin layer for bonding preferably is created by oxidation such as by an oxidizing solution or by a gaseous process such as furnace treatment under an oxygen containing atmosphere. After creating a thin oxide, the pieces can be pressed together and annealed to form a fusion bond.

In an embodiment, simpler bonding (lower process temperature, leaving more voids in the sealed mechanical junction) is carried out as compared to that used for gas pressure devices employed in gas phase infrared measurements. Accordingly, a Class 100 clean room, in many embodiments, may be used instead of a more expensive Class 10 clean room. Moreover, due to the less stringent requirements for bonding, the yield of successful machined devices is higher.

In an embodiment, the wafer includes a temperature sensor such as a thermocouple. In another embodiment each sample position has a separate temperature sensor such as a heat sensitive polychromatic or polyfluorescent indicator. In an embodiment, anodic bonding, or heat sealing via ohmic heating, is used to attach a cover to an etched material. In an embodiment, at least a portion of a machined semiconductor substrate is bonded to a glass cover slip, to cover region(s) that will not be probed by passage of infrared light. In another embodiment, bonding occurs at lower, room temperature by contacting surfaces of SiO2 with a small amount of diluted HF at the interface.

### Sample Holder Packaging of Completed Impedance Attenuator Cells

Multiple machined impedance attenuator cells preferably are made on a common material such as that represented in FIG. 5. This figure shows four rows 510 and three columns 520 of cells. Each cell has an ingress 551, reading section 552 and air vent 553.

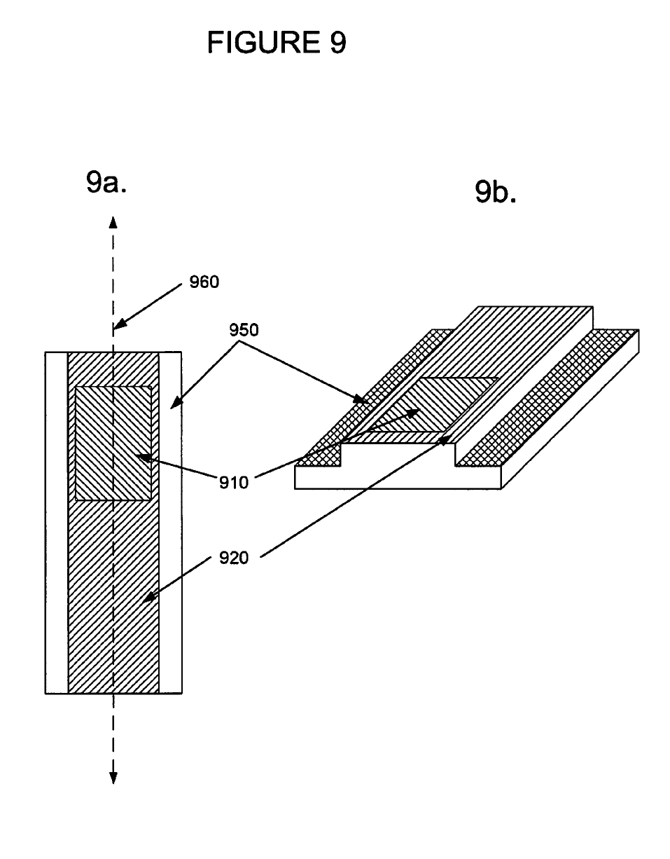

A material (910 in FIG. 9) that has etched or otherwise formed attenuator cells preferably is mounted in a cassette (920 in FIG. 9) for more convenient handling by a user or by automated equipment. Preferably the cassette is flat, with long dimensions of from 1 cm by 1 cm minimum to 10 cm by 10 cm maximum. A 1 inch by 1.5 inch by 0.138 inch thick cassette is preferred. In an embodiment the cassette has cut outs that allow mounting of a machined holder such as sealed silicon wafer assembly 20 within opening 30 as shown for holder 40 of FIG. 1.

Preferably the cassette has a cutout as shown in FIG. 9, with a flat infrared transparent machined impedance attenuator mounted in the same plane as or parallel with the main plane of the cassette. Preferably the cassette has a ridge 950 on each of two anti-parallel sides as shown in FIG. 9, to allow sliding movement into or onto the instrument along axis 960 shown in this figure. In an embodiment a separate instrument loads and/or seals the sample wells.

### Instrumentation for Using the Impedance Attenuator Cells

Signals that correspond to sample contents and/or conditions are generated by exposing an impedance attenuator cell to multiple wavelengths of probing light, and detecting light from the cell. The phrase “multiple wavelengths of probing light” in this context means at least two light wavelengths that are at least 50 nanometers apart, preferably at least 3 light wavelengths that are at least 50 nanometers apart from each other, and more preferably a wide band pass range of light such as light from 5.5 microns to 7.5 microns or more. Light from the cell may be ratioed, or otherwise analyzed by a variety of techniques. As little as two separate narrow band pass (e.g. 10 nm or less wide at 3 db down) light beams from two separate lasers may be used. In the context of analysis of biological samples such as protein in water, most preferred is to use at least one light frequency in the amide I peak region (1650 cm⁻¹+−50 cm⁻¹) simultaneously with at least one light frequency in the amide II peak (1550 cm⁻¹+−50 cm⁻¹).

A wide variety of light detection techniques are contemplated, and include those summarized, for example, in U.S. Ser. Nos. 10/366,464; 11/038,435; 11/038,550; 11/039,276; 11/133,490 and PCT/US05/44550 (earlier patent, patent applications), the contents of which, and particularly the detection instruments and methods, are incorporated by reference. Desirably, the instrument comprises a computer, a sample chip holder mounting area, an infrared source, modulator, preferably a bandpass filter, and a row of multiple detectors capable of simultaneous optical measurements from discrete locations on the sample chip.

Diode lasers that emit energy in these region(s) should be available in the future and are particularly desirable. In an embodiment, an infrared laser diode and an infra red sensor are built into the same machined and doped semiconductor. Other light sources that preferentially emit intense light, or which can be filtered to generate light in two or more regions are particularly desirable. In an embodiment an instrumentation kit is provided that comprises a larger light range analytical instrument is provided for basic research and development and a smaller light range (e.g. two or three laser light or filtered light) is provided for use in manufacturing control or quality control. In an embodiment software algorithms selected for or optimized on the larger instrument are communicated to the smaller one. Desirably, an algorithm can be modified by specifying a smaller set of frequencies for the smaller instrument. A look up table may be used in either or both instruments for conversion of a more complex algorithm from the larger instrument to a simpler algorithm (with fewer probing frequencies, for example) of the smaller instrument.

Desirably, the instrument system accepts a sample holder with pre-loaded sample(s) or adds sample(s) robotically. The instrument (or user) positions the sample holder to allow entry of the light source(s) and detection of light that emerges from the sample holder. In infrared spectroscopy experiments, it was surprisingly discovered that use of a calcium fluoride crystal as a dichroic beam splitter provided improved signal to noise ratio for probing light wavelengths of 5.5 to 7.5 nanometers. Without wishing to be bound by any one theory of this embodiment of the invention, it is believed that the CaF₂ acts as a short wavelength bandpass filter and thereby removes spurious 2^{nd} order and higher multiply reflected light, which otherwise adds received energy at longer than 10 micron wavelength.

### Prepared IR Compliant Sample

Preferably a prepared IR compliant sample comprises: 1) a sample holder as described herein with 2) aqueous sample of material and 3) surface treatment of the sample holder surface in contact with the aqueous sample wherein the surface is IR transmissive (for example between at least 5 to 8 micron IR radiation) and has an additional property selected from: a) impedance matching surface, b) hydrophobicity adjustment to optimize contact of sample with the surface.

Hydrophobicity adjustment consists of modifying the surface by a chemical process. For example available silanol groups on the surface may have coupled to them additional chemistry as are known to a skilled artisan. As another example an added amphiphilic compound such as a detergent or soap may be added and then rinsed out.

### Methods of Using Impedance Attenuator Cells

Desirably, biological samples in aqueous solution are applied to the impedance attenuator cells. The term “aqueous” includes water based solutions and partly or mostly deuterium oxide based solutions. Typically such solution is buffered and has salt (typically 0.05 to 0.25 molar salt such as sodium chloride and/or sodium/potassium phosphate). A biological sample may comprise one or more protein species, one or more nucleic acid species, and/or one or more other biological molecules in solution. In preferred embodiments a dissolved protein at high concentration (at least 2% of its saturation concentration, and preferably at least 10% of its saturation level) is present with one or more salts in water. Preferably a buffer is used to maintain a pH such as a pH between pH 6 and 8.

Samples are placed in a machined holder that preferably is mounted in a chip and inserted into the instrument. Preferably, aqueous samples of protein or other material are prepared and then added to separate multiple wells in the machined holder. The sample holder may contain, for example, at least 16, at least 25, at least 100 or more sample chambers. A variety of application techniques are well known and contemplated, including passive entry via capillary wicking action from a small drop adhered to a pick up pin. Optionally, entry of fluid into the sample holder is checked by detection of an optical change. For example, infrared transmission or emission measurements can be made repeatedly to determine whether a particular sample position has been filled with an intrared absorbing or emitting material. In an embodiment, impedance attenuator cells are placed into a thermally controlled chamber that is purged with dry nitrogen gas.

Spectroscopic measurements are carried out, preferably simultaneously on multiple impedance attenuator cells. In an embodiment, the temperature of the cells is increased or decreased during and or after measurement. In an embodiment, an optic temperature sensor, thermister, or other sensor is located on or in the machined holder. In an embodiment, temperature is determined from measuring infrared changes from the sample or of a reference material from the holder.

Chemical reactions such as binding reactions, allosteric interactions driven by environmental changes (pH, temperature, pressure) or presence/altered concentration of an effector may be carried out before or during spectroscopic measurements. For example, an impedance attenuator cell may include a chromatography section between sample application port and a spectroscopic read section. Chemical(s) may be added to the sample ingress port or added to particles that may be immobilized there, Such chemicals anywhere in the sample entry and passage spaces may dissolve and participate in a chemical reaction, serve as calibration markers and/or be immobilized and remove substances from sample by binding.

During and or after spectroscopic data collection, data are analyzed by any of a large variety of algorithms as stored programs in a computer that may be part of the instrument or that may receive data from the instrument. A bar code or other identification device preferably is included on the sample holder and provides identification information that preferably is permanently added to data sets that are made by the instrument. A time and date stamp preferably also is included.

### Optional Sealing of Impedance Attenuator Cells

After sample application, the sample openings preferably are sealed. The term “sealed” in this context means that a material is added that covers or at least partially fills the opening to prevent sample from exiting. In an embodiment, a cover slip is applied that mechanically seals at least the sample entry and vent holes. In a preferred embodiment, a viscous fluid is applied to the entry holes and vent holes as a seal to prevent evaporation. Viscous fluid optionally is applied only to entry holes, if the vent holes are small enough or otherwise occluded to avoid significant evaporation.

A variety of viscous fluids may be used for sealing. Preferred are substances that are not miscible with water and that have a viscosity of greater than 50 centi-Poise (“cP”). For use with samples that are to be heated, higher viscosities are preferred to minimize efflux of sample fluid. Preferred are non-water miscible substances having greater than 500 cP, 750 cP, 1000 cP or even greater than 1500 cP. In a preferred embodiment, the substance viscosity does not decrease more than 10% per 10 degrees C. with increasing temperature, or actually increases, with increasing temperature. Commercially available single part UV adhesives are preferred. The adhesive preferably is biologically inert and may be a UV catalyzed epoxy. Use of a UV radiation curable one part adhesive particularly is desirable inb combination with a UV opaque but IR transmissive sample holder.

A variety of sealing materials are contemplated as will be understood by a skilled artisan after reading this specification. Thermosetting polymers such as Plurmic™, from BASF, triblock co-polymers such as Pluronic F68 and Pluronic F127 are especially desirable. Castor bean oil, particularly after air oxidation, was surprisingly found very useful for some studies as this material resisted losing viscosity at higher temperatures better than other materials.

Most desirably a sealed cell as described herein also includes a gas expansion reservoir (“appendix”) that preferably has been etched into at least one part of the holder before assembly. The reservoir accepts excess biological fluid. Typically at least some biological fluid is in contact with or enters contact with the reservoir during use. A desirable procedure is to prepare a sample by adding biological fluid, seal one or more apertures to the sample holder, then change temperature or otherwise change the volume of the biological sample such as for example, by heating. The reservoir accepts a volume change without overly stressing the aperture seals by opening them up.

### Noise Filtering Techniques

Embodiments provide computer algorithms for i. data input to allow rapid storage and analysis (including correction of background) of media blank (which may be buffered water) over a range. Algorithms that input two or more matrices and subtract one from the other, preferably after or during factoring adjustment of at least one matrix data set, followed by a storage step for the calculated result, and generating a new, calculated matrix (or modification of a starting matrix) are preferred because such subtraction and simple storage provides speed. A variety of chemometrics techniques are available to a skilled artisan and are contemplated. An algorithm may be used that inputs a set of data that corresponds to a continuous physical relationship, such as spectral data over a wavelength range or obtained over a time range, and that breaks a continuous set into components in order to separately analyze the separate parts. Peak optimization algorithms and simplex programming are particularly preferred as algorithms and algorithm subcomponents.

### Correction by Ratiometric Analysis

Many of the potential multiplicative errors in the spectrometer and other errors such as the effect of water can be eliminated by ratiometric analysis. In addition, spectral contributions from environmental factors such as atmospheric absorbances (e.g. water, CO2, and others) can be ratiometrically eliminated by the simultaneous measurement of the sample and the reference spectra. Ratiometric comparison algorithms minimize the multiplicative errors in the system and noise contributions from atmospheric absorbances.

A ratiometric algorithm may operate by inputting a first set of data, inputting a second set of data, algebraically comparing member(s) of the first set with member(s) of the second set, and then outputting a comparison. Typically the algorithm operates in a computer and the outputted data are placed in memory locations.

Preferably, differential measurements involve spectra collected in different times and using different spatial detectors. A sample chip layout example for referencing temporal and spatial errors out of the data is shown in Table 2 below.

TABLE 2

| | | | | |
|---|---|---|---|---|
| R₁₁ | R₂₁ | R₃₁ | R₄₁ | R₅₁ |
| R₁₂ | R₂₂ | S₃₂ | S₄₂ | S₅₂ |
| R₁₃ | S₂₃ | S₃₃ | S₄₃ | S₅₃ |
| R₁₄ | S₂₄ | S₃₄ | S₄₄ | S₅₄ |
| R₁₅ | S₂₅ | S₃₅ | S₄₅ | S₅₅ |

This table is a grid wherein S = sample wells; R = references

A particularly desirable algorithm uses the following definitions:

| | |
|---|---|
| Sample well | Wᵢⱼ |
| Transmittance | Tᵢⱼ(v) |
| Absorptivity | aᵢⱼ(v) |
| Absorbance | Aᵢⱼ(v) = −log₁₀ (Tᵢⱼ(v)) |
| Beer's Law | ${A}_{ij} ( v ) {c}_{r} {l}_{ij} + {\sum }_{p} {a}_{{p}_{ij}} {c}_{{p}_{ij}} {l}_{ij}$ |

| | |
|---|---|
| Optical pathlength | lᵢⱼ |
| Absorptivity of reference fluid | aᵣ |
| Absorptivity of protein fluid pᵢⱼ | aₚᵢⱼ |
| Concentration of reference fluid | cᵣ |
| Concentration of protein fluid pᵢⱼ | cₚᵢⱼ |
| The measured spectrum | Sᵢⱼ |
| Spatial variation | |

In an embodiment, all of the samples in column “j” are measured at the same time tj; the spectral sensitivity may vary from row to row and from time to time; and the variations in spectral sensitivity with time and space are separable. In these circumstances, spectra data are:

Sᵢⱼ(v)=rᵢ(v)cⱼ(v)Tᵢⱼ(v)

This reduces to

Sᵢⱼ=rᵢcⱼTᵢⱼ

when the frequency dependence is understood.

A desirable water correction method and algorithm may have one or more of the following steps:

A desirable multiple sample well holder is provided. One column and one row of wells on the chip are filled with the reference fluid. As seen in Table 2, the first column and the first row of the multiple sample chip are filled with references. Well R22 is also filled with the reference fluid. All other sample wells are available for unknown fluids. The depth of all of the sample wells except well R22 is as close to a constant lo as possible, but sample well R22 has a different depth, say I₀+I_{A}.

In an embodiment background is corrected and signal to noise improved by using the same infrared detection elements for sample and reference. This is particularly useful for protein melting studies. In such studies, one or more spectroscopic signals for a given sample capillary read space, are matched with one or more spectroscopic pixels for background reference subtraction. A background subtraction reference may include, for example, water background, filter paper background used for optional dried samples, background effects of air, detector pixel errors, optic errors and/or other background.

### Temperature Control

A sample holder typically is temperature controlled by thermal conduction. A thermister may be positioned in contact with the sample chip, or built into the chip. Alternately or in combination, a separate infrared sensor may be used to detect temperature. Inferred temperature also can be calculated from analysis of data obtained from the imaging sensor.

In an embodiment, the temperatures at different locations within the sample chip are assayed while the chip is heated or cooled. In this case, the temperature data are correlated with specific assay behavior of samples. Simultaneous temperature and absorbance spectra may be obtained for individual pixels and for groups of pixels.

Other combinations of the inventive features described above, of course easily can be determined by a skilled artisan after having read this specification, and are included in the spirit and scope of the claimed invention. References cited above are specifically incorporated in their entireties by reference and represent art known to the skilled artisan.

1. A sealed unitized spectroscopic sample holder comprising:
a first etched, slab, with multiple fluid well capillaries etched parallel to and on a back side of the slab surface, with each well having a common etch and further comprising etched holes from a front side of the slab surface and connecting to the capillaries on the back side and apertures for applying sample;
a second, flat slab wherein the second slab is positioned and forms a seal with the back side of the first etched flat slab,
further comprising a biological aqueous sample within at least one of the capillaries and wherein
the surfaces of the one or more capillaries in contact with the biological aqueous sample comprise an impedance matching layer for infrared light transmission and wherein the apertures for applying sample are sealed against evaporation loss.

2. The holder of claim 1, wherein the multiple optical wells have precision-controlled light path lengths of between 2 and 75 microns with a standard deviation of less than 0.5 microns.

3. The holder of claim 1, wherein the impedance matching layer comprises a coating selected from the group consisting of silicon oxide, silicon nitride and silicon oxynitride.

4. The holder of claim 2, wherein the standard deviation is less than 0.2 microns.

5. The holder of claim 2, wherein the standard deviation is less than 0.05 microns.

6. The holder of claim 1, wherein the multiple optical wells have light path lengths of between 3 and 5 microns.

7. The holdler of claim 6, wherein the multiple optical wells have light path lengths of between 3.5 and 4.1 microns.

8. The holder of claim 1, wherein the multiple optical wells have a light path length of between 50 and 70 microns and the aqueous sample comprises deuterium.

9. The holder of claim 1, wherein the impedance matching layer is between 100 and 1000 angstroms thick.

10. The holder of claim 1, wherein the impedance matching layer has sufficient thickness to minimize reflection of 4.5 micron light.

11. The holder of claim 1, wherein the entire surfaces of the principal flat surfaces are coated with the impedance matching layer.

12. The holder of claim 1, wherein the biological sample comprises at least 1 mg/ml of protein.

13. The holder of claim 1, wherein the apertures are sealed by a sealant that prevents evaporation.

14. The holder of claim 13, wherein the sealant is a water immiscible fluid.

15. The holder of claim 14, wherein the water immiscible fluid has a viscosity of greater than 50 centi-poise.

16. The holder of claim 14, wherein the water immiscible fluid has a viscosity that does not decrease by more than 10% per 10 degrees centigrade increase in temperature.

17. The holder of claim 13, wherein the well bottom opening comprises particles that are immobilized on at least the well bottom or well walls.

18. The holder of claim 13, wherein the sealant is at least one material selected from the group of: an adhesive that binds to the particles after application to the well, a tape and a mechanical sealant.

19. A sealed unitized infra red transmissive spectroscopic sample holder comprising:
a first etched, slab, with two or more multiple fluid well capillaries etched parallel to and on a back side of the slab surface, with each well having a common etch and further comprising etched sample application holes from a front side of the slab surface and connecting to the capillaries on the back side and apertures for applying sample;
a second, flat slab wherein the second slab is positioned and forms a seal with the back side of the first etched flat slab,
further comprising an appendix with entrapped air associated with each capillary,
the appendix having an interior space that is continuous with the respective capillary and wherein each capillary sample application hole is sealed against evaporation, wherein the appendix is sized to allow expansion of aqueous fluid from the associated capillary into the appendix in response to temperature changes.

20. The sample holder of claim 13, wherein each appendix has a volume of less than 2% of its respective total capillary volume.
